(19) United States
(12) Patent Application Publication
(10) Pub. No.: US 2024/0152739 A1
(43) Pub. Date: May 9, 2024

(54) DEVICE AND METHOD FOR DENOISING AN INPUT SIGNAL

(71) Applicant: Robert Bosch GmbH, Stuttgart (DE)

(72) Inventors: Anna Khoreva, Stuttgart (DE); Dan Zhang, Leonberg (DE)

(21) Appl. No.: 18/548,151

(22) PCT Filed: Jun. 10, 2022
(86) PCT No.: PCT/EP2022/065898

§ 371 Date: Aug. 28, 2023

(30) Foreign Application Priority Data
Jun. 15, 2021 (DE) 10 2021 206 110.9

(51) Int. Cl. G06N 3/0475; G06N 3/09

(52) U.S. Cl. CPC G06N 3/0475; G06N 3/09

(57) ABSTRACT

A computer-implemented method for determining a classification and/or regression result based on a provided input signal. The method includes: providing a first part, configured to denoise the provided input signal based on the input signal and a randomly drawn first value; randomly drawing a plurality of first values; determining, by the first part, a plurality of denoised signals, wherein denoised signals are each determined based on the provided input signal and a first value from the plurality of first values; determining, by a model, a plurality of predicted values based on the denoised values, wherein each predicted value characterizes a classification of a denoised signal or a regression results based on a denoised signal; providing an aggregated signal characterizing an aggregation of the predicted values, wherein the aggregated signal characterizes the classification and/or regression result determined by the method.

### FIELD

The present invention relates to a method for training a machine learning system for denoising input signals, a method for denoising an input signal, a training device, a computer program and a machine-readable storage device.

### BACKGROUND INFORMATION

Kupyn et al., “DeblurGAN-v2: Deblurring (Orders-of-Magnitude) Faster and Better”, 2019, https://arxiv.org/abs/1908.03826v1 describes a neural network for deblurring an input image.

Signal denoising is an oft-occurring problem in a variety of technical fields. Especially if a signal is measured by a sensor, the signal may exhibit a substantial amount of noise, which needs to be filtered in order to obtain a clean signal. When using signals for control tasks, e.g., steering an autonomous robot, denoising sensor signals is essential.

For example, when controlling a robot based on visual signals, e.g., camera images, the visual signals may serve as means for determining a virtual copy of the environment the robot operates. This virtual copy of the environment may then be used for determining suitable actions of the robot which may then be executed in the real world. In this context, it is essential that similar phenomena in the environment result in similar visual signals such that the robot may react to them consistently and reliably. If the visual signal is corrupted by a substantial amount of noise, processing the signal may lead to wrong actions taken by the robot.

As already alluded to, the necessity for denoising signals is, however, not limited to visual signals only, but extends to a variety of use cases featuring a sensing device, e.g., when recording audio signals, determining the state of an engine with piezo sensors or performing ranging with radar, ultrasound or LIDAR sensors.

In general, noise may be understood as a general term for unwanted (and, in general, unknown) modifications that a signal may suffer during capture, storage, transmission, processing, or conversion. There exist different types of noise, which may, for example, be differentiated based on their statistical features (e.g., white noise, black noise or Brownian noise). In the context of the present invention, noise may also be understood as deriving from recording conditions of a signal, e.g., the rain drops seen in an image may be understood as noise or a motion blur resulting from a moving sensor recording the signal may be understood as noise.

Conventional methods use deterministic models for denoising input signals. The problem with this approach, however, is that noise in an image constitutes a loss of information. Using deterministic approaches, this loss of information often cannot be compensated satisfactorily. It is hence desirable to devise a method that takes into account the inherent ambiguity or uncertainty that comes with a loss of information in a signal due to noise.

### SUMMARY

In a first aspect, the present invention concerns a computer-implemented method for determining a classification and/or regression result based on a provided input signal. According to an example embodiment of the present invention. According to an example embodiment of the present invention, the method comprises the following steps:
Providing a first part, wherein the first part is configured to denoise the provided input signal based on the input signal and a randomly drawn first value;
Randomly drawing a plurality of first values;
Determining, by the first part, a plurality of denoised signals, wherein the denoised signal from the plurality of denoised signals are each determined based on the provided input signal and a first value from the plurality of first values;
Determining, by a model, a plurality of predicted values based on the denoised values, wherein each predicted value characterizes a classification of a denoised signal or a regression results based on a denoised signals;
Providing an aggregated signal characterizing an aggregation of the predicted values, wherein the aggregated signal characterizes the classification and/or regression result determined by the method.

The term noise may be understood as the term known from the field of signal processing. That is, noise may be understood as a general term for unwanted (and, in general, unknown) modifications that a signal may suffer during capture, storage, transmission, processing, or conversion.

In the context of the present invention, a signal may be understood as comprising at least one but preferably multiple values, which may be organized in a predefined form or shape. For example, a signal may characterize scalar values that have been recorded over a predefined amount of time, i.e., the signal may characterize a time series. The values of a signal may also be organized in form of a vector, a matrix or a tensor, e.g., the values of the signal may characterize pixels of an image or voxels of a volumetric entity. The provided input signal may, for example, characterize an image, an audio signal or a recording form a sensor, e.g., a piezo sensor, a temperature sensor, a pressure sensor or a sensor for measuring acceleration.

An input signal may especially be determined, e.g., recorded, by a sensor.

If an input signal is corrupted by noise, i.e., the signal is a noisy signal, this can be understood as a loss of information in an original signal, wherein the noise overlays some or all of the values of the original signal to form the noisy signal. Recovering the values of the original signal is a difficult and sometimes even impossible problem. It is, however, possible to estimate the values of the original signal. The processes of estimating the original values of a signal, i.e., the values of the clean signal before the addition of noise, can be understood as denoising. If an input signal is non-noisy, denoising should preferably determine the input signal as denoised signal.

The first part may be understood as a machine learning model, which is configured and trained to denoise a signal provided to the first part. In this sense, determining an output by the first part based on a signal may be understood as supplying the signals as input to the machine learning model and determining an output.

The first part is configured such that it accepts the provided input signal and the randomly drawn first value as inputs in order to denoise the provided input signal. Preferably, the first value is part of a vector, matrix or tensor of random first values, which are supplied as input alongside the provided input signal. In other words, the first part may preferably be supplied with multiple first values for the provided input signal.

The method may be understood as determining a plurality of possible denoised signals for the provided input signal, wherein the output signals characterize the denoised signals. This is done in a probabilistic fashion, i.e., the output signals may be understood as what the first part considers most likely denoised version of the input signal.

According to an example embodiment of the present invention, preferably, an output signal is determined for each first value. Preferably, the plurality of first values is characterize by a plurality of vectors, wherein each first value is part of a distinct vector from the plurality of vectors.

Having obtained the denoised signals, the model is used to determine either a classification of the provided input signal or perform a regression based on the provided input signal, i.e., determine the result of a regressions, i.e., a regression result, based on the input signal. To put it in other words, the model is configured for classification and/or configured to perform a regression analysis. While classifying may be understood as assigning at least one discrete value to the input signal, performing a regression analysis may be understood as assigning at least one continuous value to the provided input signal.

Typical embodiments of classification may be semantic segmentation, object detection, multi-label classification or multi-class classification.

According to an example embodiment of the present invention, in the method, the plurality of predicted values is preferably determined such that for each denoised signal a predicted value is determined from the model. In essence, this may be understood as determining the likely classifications and/or regressions results of the provided input signal with respect to a plurality of hypothesis of denoised signals for the input signal.

The plurality of predicted values may then be aggregated, wherein the term “aggregated” is preferably understood as combining the predicted values into the aggregated signal, wherein the aggregated signal characterizes the output of the method. For example, if the predicted values are all discrete values characterizing classifications, a known method for combining the different classifications may be used, e.g., majority voting. If the predicted values characterize probabilities or real-valued regressions results, the aggregation may be achieved by means of averaging the values. If the model outputs predicted values characterizing both classifications as well as regression results, those predicted values may be aggregated that characterize classifications and/or those predicted values may be aggregated that characterize regressions results. In other words, it is preferred that predicted values characterizing classifications are not combined with predicted values characterizing regressions results.

An advantage of the proposed approach according to the present invention is that, instead of using a single denoised signal to determine the output of the method, multiple hypothesis for a denoised signal based on the input signal are determined. Hence not a single denoised signal is taken into account when determining the output of the method, but a plurality of different hypothesis for the denoised signal. The inventors found that this increases the accuracy of the classification determined by the method and/or the accuracy of the regression result determined by the method.

In preferred embodiments of the method of the present invention it is possible that additionally a third value is provided by the method, wherein the third value characterizes a variance of the predicted values.

This may be understood as also providing a measure of uncertainty about the output of the method alongside the classification and/or regression result. Advantageously, this allows a human in a guided human-machine interaction to infer how confident the output of the method is, i.e., how likely it is that the classification and/or regression result is accurate. Another advantage of the determined variance is that downstream applications, which use the result of the method for further processing, are given more information to base their decision on. For example, downstream applications may chose to reject the classification and/or regression result characterized by the aggregated signal if the variance value exceeds a predefined threshold.

In preferred embodiments of the present invention, it is also possible that the first part is provided based on training the first part to denoise a provided input signal, wherein training the first part comprises the steps of:
Providing a first input signal and a first value to the first part, wherein the first input signal characterizes a noisy signal and the first value characterizes a randomly drawn value;
Determining, by the first part, a first output signal for the first input signal and the first value;
Determining, by a second part, a second value based on the first output signal, wherein the second value characterizes a probability of the first output signal to characterize a noisy signal;
Determining, by the second part, a third value based on a supplied second input signal, wherein the second input signal characterizes a non-noisy signal and wherein the third value characterizes a probability of the second input signal to characterize a non-noisy signal;
Training the first part and the second part wherein training comprises:
   Adapting a plurality of parameters of the first part according to a gradient of the second value with respect to the plurality of parameters of the first part;
   Adapting a plurality of parameters of the second part according to a gradient of a sum of the second value and the third value with respect to the plurality of parameters of the second part.

Providing the first part based on training may be understood as training the first part according to the above-stated embodiment and then using it for the method to determine a classification and/or regression result. It may also be understood as using a first part for the method to determine a classification and/or regression result, wherein the first part has been trained according to the above stated embodiment.

The first part and second part may be understood as sub-components of a machine learning system, which is used to train the first part. The machine learning system may be understood as a generative adversarial network (GAN). The first part can be understood as a generator of the GAN and the second part as a discriminator of the GAN. In terms of GAN terminology, the method for training may be understood as a zero-sum game between the first part and the second part of the machine learning system. The first part seeks to generate output signals from the input signal that faithfully resemble a denoised signal, while the second part seeks to discriminate between signals generated from the first part and non-noisy signals. During training, the first part hence learns to generate more and more “denoised looking” input signals to the point where an output signal from the first part cannot be differentiated anymore from a non-noisy signal.

Information concerning the characteristics of clean signals, i.e., signals with no or only a negligible amount of noise, are injected into the training process via the second input signal, which can be understood as a clean signal. By virtue of the first input signal and the second input signal, the machine learning system is provided information about noisy signals and non-noisy signals respectively.

The second part can be understood as trying to learn the difference between output signals generated by the first part with respect second input signals. In contrast, the first part seeks to generate output signals that cannot be discerned from a clean signal. In essence, this leads to the first part learning to generate clean output signals based on noisy input signals. In other words, the first part learns to denoise an input signal.

According to an example embodiment of the present invention, preferably, the first part and the second part are realized as neural networks. Preferably, the neural networks are trained using a gradient-based algorithm. For training, a loss function may be defined, which is minimized during training of the machine learning system. Preferably, the second value is a negative log-likelihood of the output signal to be classified as a noisy signal and the third value is a negative log-likelihood of the second input signal to be classified as a clean signal, i.e., a signal without noise.

According to an example embodiment of the present invention, for training, a loss function may then be constructed based on the second value and the third value. For example, the loss function could be characterized by a sum of the second value and the third value. The first part may then be trained by means of a gradient ascent algorithm on the loss function while the second part may be trained with a gradient descent algorithm. Alternatively, the first part may also be trained by gradient descent on the negative loss function. As the training of the first part affects only the second value, training the first part may also be conducted by means of a gradient ascent algorithm based on the second value only.

According to an example embodiment of the present invention, it is also possible that for training a plurality of first input signals and second input signals are used in each step of the respective gradient based algorithm. In this case, the loss function may characterize an average of the loss functions for the individual samples.

An advantage of the proposed approach according to the present invention is that in addition to the first input signal the first part is also supplied with the first value, wherein the first value may preferably be drawn at random from a predefined probability distribution during each step of training. In the following it will be described why this is an advantageous feature of the present invention.

As described above, given the values of a noisy signal, the original values of a clean signal, that became the noisy signal by applying noise, can often times not be recovered. Without further information, the original value of a corrupted value of a signal could be in a large range of values. One may, however, determine a probability distribution of the original value. If such a probability distribution is present. This probability distribution then allows for multiple ways of estimating the original value, for example by drawing a value at random from this distribution and providing this value as estimation of the original value or drawing multiple values from the probability distribution and providing an expected value of the drawn values as estimation of original value.

The first part may hence be understood as a model for estimating the original values of the first input signal. As the first part is supplied with the randomly-drawn first value, it is incentivized to learn to generate different output signals given the same first input signal but different first values. Preferably, the first part is supplied with a plurality of first values for a first input signal, wherein the plurality of first values may be drawn from a multivariate probability distribution.

Another advantage of the present invention is that the first part is capable of learning to denoise input signals of different types of noise. For example, if the input signal to be denoised is an image, the types of noise may be random pixel noise, glare, blur or noise dependent on the content of the image, e.g., rain. The inventors found that the first part is capable of learning to remove multiple different types of noise. The first value has the effect of guiding the process of noise removal. For example, when using a neural network as first part. The noise may be provided as input to the neural network at arbitrary layers of the neural network, wherein the position of the layer the first value is provided to as input as a direct influence on the noise removal. For example, if the first value is provided as input to a first layer of the neural network, the first value effects local parts of the input signal, e.g., neighboring pixel in an image or neighboring points in an audio signal. This is because neural networks process local features in their earlier layers. In contrast, providing the first value as input to a last layer of the neural network effects global parts of the input signal, e.g., areas of an image or sections of an audio signal. This is because neural networks process global features in their later layers. When providing the first value to a layer in between the first and last layer, the effect can be gradually shifted from local parts of the input signal (earlier layers) to global parts of the input signal (later layers). This is especially helpful if the type of noise to be removed by the first part can be narrowed down. For example, if it is known that the noise to be expected in the input signal is of a local nature, e.g., pixel noise, the first value can be provided to a earlier layer. In contrast, if the noise to be expected in the input signal is of a global nature, e.g., noise due to weather effects such as rain, the first value can be provided to a later layer.

In summary, the first value has the effect of steering the denoising process and improves the quality of the denoised signal, i.e., allows for achieving a better denoising performance.

The types of noise, which the first part shall learn to remove, can be defined by means of the first input signal or the plurality of first input signals. If a type of noise is present in the first input signals, the first part is able to learn to remove that type of noise. The first input signals may hence be understood as a training dataset, wherein the specific composition of noise in the first input signals may be understood as defining which type of noise can be removed from an input signal using the first part after training.

Another advantage of training a single model to process multiple types of noise according to the present invention is that the first part also learns to generalize better to unseen noise at inference time compared to if it was only trained based on one type of corruption. In other words, if, after training, noise is presented to the first part, which was not observed during training of the first part, the first part is capable to predict a denoised output signal more accurately.

In summary, the specific design of the machine learning system according to the present invention in combination with the proposed training algorithm of the present invention leads to the first part being able to estimate a clean version of a supplied input signal for different types of noise. As the first part is capable of discerning different types of noise, the generated output signal resembles the clean signal more accurately. In other words, the denoising of the input signal is improved.

According to an example embodiment of the present invention, it is also possible that the method for training the machine learning system further comprises the steps of:
Providing a third input signal and a fourth value to the first part, wherein the third input signal does not characterize a noisy signal;
Determining, by the first part, a second output signal for the third input signal and the fifth value;
Adapting the plurality of parameters of the first part according to a deviation of the second output signal to the third input signal.

An advantage of this specific embodiment of the present invention is that the first part learns to not denoise input signals, which are not noisy in the first place. In general, this leads to an improved performance of the first part when handling both noisy input signals as well as input signals, which do not exhibit noise. For example, the machine learning system may be configured to process camera images that are recorded over the course of a day. While at dawn, dusk and night the images may be noisy due to recording process of the camera, images recorded during the day when sufficient light is available may only exhibit a negligible amount of noise. Here, the first part trained with the additional features as described above would be capable of being applied to camera image irrespective of the actual amount of noise that is present in the image.

Another advantage of this embodiment of the present invention is that the first part is trained to take into account the input signal when determining the output signal. In other words, it enables the first part not to solely rely on the first value when determining the output signal. This improves the denoising even further.

Similar to the first value, the fourth value may preferably be randomly drawn. In preferred embodiments, a plurality of fourth values may be provided for a third input signal, e.g., in form of a vector, matrix or tensor.

In further embodiments of the present invention, the second input signal may be used as third input signal. In these embodiments, the first value may be used as fourth value or another random value may be drawn as fourth value.

The deviation of the second output signal to the third input signal may be characterized by a loss function that determines a distance between the second output signal and the third output signal, e.g., a Euclidean distance or a Manhattan distance. This loss function may be considered as enforcing the first part to learn to copy an input signal as output signal in case of no noise in the input signal. The loss function explained above may hence be considered an identity loss function. For training the identity loss function may be added to the loss function from the GAN training described above to form a global loss function.

Preferably, the identity loss function may be weighted by a predefined factor in the global loss function.

In a preferred embodiment of the present invention, it is also possible that the method for training further comprises the steps of:
Determining, by the first part and based on the first input signal and the first value, a fifth value characterizing a classification of the type of noise characterized by the first input signal;
Adapting the plurality of parameters of the first part according to a deviation of a class characterized by the fifth value and a class of noise type corresponding to the first input signal.

This approach may be understood as tasking the first part of the machine learning system additionally to classify the type of noise present in the input signal. The inventors found that this form of supervised training of the first part acts as a regularization for training and enhances the performance of the first part even further as it is presented with even more information regarding the noise to be removed.

In this embodiment of the present invention, the first input signal is assigned a class label characterizing the type of noise that the first input signal exhibits. This class label may either be assigned by an expert or be determined through unsupervised labeling methods, e.g., by clustering noisy first input signals, wherein a cluster membership of a first input signal determines the desired class the first part shall predict. In any case, the assigned class and/or the assigned class label may be considered as corresponding to the first input signal.

Another advantage of this specific embodiment of the present invention is that downstream applications may be provided the output signal for a given input signal as well as the classification of the first part of the machine learning system. This way, the downstream applications are given more information about the input signal before denoising, which enables the downstream applications to process the output signal even more accurately.

In a preferred embodiment of the present invention, it is also possible that the method for training further comprises the steps of:
Determining, by the first part and based on the third input signal and the fourth value, a fifth value characterizing a classification of the type of noise characterized by the third input signal;
Adapting the plurality of parameters of the first part according to a deviation of a class characterized by the fifth value and a class characterizing an absence of noise.

An advantage of this embodiment of the present invention is that the first part also learns to classify input signals, which are non-noisy. The inventors found out that this improves the denoising performance of the first part even further.

When training with the third input signal, it is preferred that the deviation of the second output signal to the third input signal is characterized by the formula

[symbol]

_{G,id}= [symbol] ₓ_{⁽³⁾}{∥x⁽³⁾−G(x⁽³⁾, z=0)∥ₚ}+ [symbol] ₓ_{⁽³⁾}_{,z}_{₁}_{,z}_{₂}{∥G(x⁽³⁾, z=z₁)−G(x⁽³⁾, z=z₂)μₚ}, wherein x⁽³⁾ is the third input signal, G is the first part, z denotes an argument of the function G, i.e., the first part, and z₁ and z₂ each denote randomly drawn first values, i.e., realizations of the first value.

According to an example embodiment of the present invention, it is possible that multiple third input signals are used for training, for example in form of a batch-wise training of the machine learning system. For each third input signal in a batch of third input signals used for training the respective first values may be drawn at random for each training step. In this case, the loss function may preferably characterize an expected loss over each of the third input signals as denoted by the expected values [symbol] in the formula above.

An advantage of this embodiment of the present invention is that the first part is trained to learn to output the input signal as output signal if the input signal is non-noisy. This is achieved by training the first part to not consider the first value when faced with a non-noisy input signal. This agnostic behavior towards the first value in case of a non-noisy signal is achieved by presenting the first part with two randomly drawn first values for the third input signal and training the first part of the machine learning system to minimize a distance between output signals for the third input signal y with respect to the two randomly drawn first values (see the second summand of the loss function).

In even further embodiments of the present invention, it is also possible that the first part is additionally trained based on a loss function characterized by the formula

[symbol]

_{G,div}= [symbol] ₓ_{⁽⁴⁾}_{,x}_{⁽⁵⁾}_{,z}_{₁}_{,z}_{₄}{max{0, ∥G(x⁽⁴⁾, z₃)−G(x⁽⁴⁾, z₄)∥ₚ−∥G(x⁽⁵⁾, z₃)−G(x⁽⁵⁾, z₄)∥ₚ+τ}},

wherein x⁽⁴⁾ and x⁽⁵⁾ are noisy input signals and x⁽⁴⁾ is noisier than x⁽⁵⁾. Training the first part based on the loss function characterized by the formula above leads to the first part generating more diverse output signals if the amount of noise in the input signal increases. In other words, if the supplied input signal is noisier than another signal, the possible output signals for the supplied input signal should have a larger variety than the output signals determined for the other signal. The inventors found that this approach leads to an increase in the prediction performance of the model.

According to an example embodiment of the present invention, for training, the signals x⁽⁴⁾ and x⁽⁵⁾ may be sampled at random from a training dataset. In order to determine which of the two signals is noisier, standard metrics may be used, e.g., signal-to-noise ratio. If the noise in the image is of a semantic nature (e.g., rain or snow fall), additional meta data of the input signals characterizing the strength of the respective noise may also be used.

Training the first part this way involves a hyperparameter T, which may be understood as a margin of the optimization problem, i.e., characterizing the difference in variance of the output signals for x⁽⁴⁾ and x⁽⁵⁾.

It is also possible to use a clean input signal for x⁽⁴⁾. The authors found that this further increases the ability of the first part to generate diverse output signals for increasingly noisy input signals and hence further increases the performance of the model.

As the first part should not make any change on clean, i.e., non-noisy input signals, the term ∥G(x⁽⁴⁾, z₁)−G(x⁽⁵⁾, z₂)∥ₚ in the above formula can also be replaced with ∥x⁽⁴⁾−G(x⁽⁴⁾, z₂)∥ₚ if x⁽⁴⁾ is a clean input signal or can also be replaced with ∥x⁽⁴⁾−G(x⁽⁴⁾, 0)∥ₚ if x⁽⁴⁾ is a clean input signal.

In another aspect, the present invention concerns a computer-implemented method for determining a denoised signal from an input signal comprising the steps of:
Providing a first part according to an embodiment of the training method presented above;
Determining an output signal by the first part based on the input signal and a randomly-drawn first value;
Providing the output signal as denoised signal.

The method for denoising can be understood as applying the first part of the machine learning system obtained in the method for training. The feature of providing the first system can be understood as training the first part according to an embodiment of the training method presented above and then providing the trained first part. Alternatively, it can also be understood as using a first part that is configured according to an embodiment of the present invention and/or has been trained with the method according an embodiment of the present invention.

For denoising, the first part of the machine learning system can be used as it has learned to determine denoised signals given an input signal. The advantage is that the first part is able to determine the denoised signals with a high accuracy. Another advantage of the proposed approach is that non-noisy input signals may also be used as input for the denoising method as the first part has learned to handle them separately, i.e., to preserve the values of a non-noisy input signal as best as possible. In a signal processing pipeline, the first part may hence be applied to an input signal before further processing as it generally enhances the performance of the downstream tasks, e.g., classifying data from the input signal (for example object detection in images, speaker classification in audio signals, classifying a time point of a closing of a valve of an injector of an engine, wherein the sensor signal characterizes data form a piezo sensor of the valve).

An advantage of this approach is that the output signal (which may be understood as denoised input signal) can be used for downstream tasks more efficiently as denoising allows for a better processing in downstream tasks, e.g., when classifying the output signal as proxy for classifying the input signal. This improves the performance of the downstream tasks, e.g., classification performance.

For example, it is possible that the denoised signal is used as input to a virtual sensor for determining a property of the input signal that is not measured by the input signal itself.

In general, it is possible that the denoised signal is used as input of a control system, wherein the control system is configured to determine a control signal of an actuator based on the denoised signal.

According to an example embodiment of the present invention, the control system may, for example, be configured to control an at least partially autonomous robot, wherein the input signal is a sensor signal characterizing a perception of the robot's environment and the control signal controls at least parts of an action of the robot. The advantage here is that by denoising the input signal the control system may perceive the environment more accurately and hence determine better actions by the robot by means of a more suitable control signal of the actuator.

Embodiments of the present invention will be discussed with reference to the figures in more detail.

### BRIEF DESCRIPTION OF THE DRAWINGS

FIG. 1 shows a machine learning system, according to an example embodiment of the present invention.

FIG. 2 shows a training system for training the machine learning system, according to an example embodiment of the present invention.

FIG. 3 shows a control system for controlling an actuator based on an output signal of the machine learning system, according to an example embodiment of the present invention.

FIG. 4 shows the control system controlling at least partially autonomous vehicle, according to an example embodiment of the present invention.

FIG. 5 shows the control system controlling a valve, according to an example embodiment of the present invention.

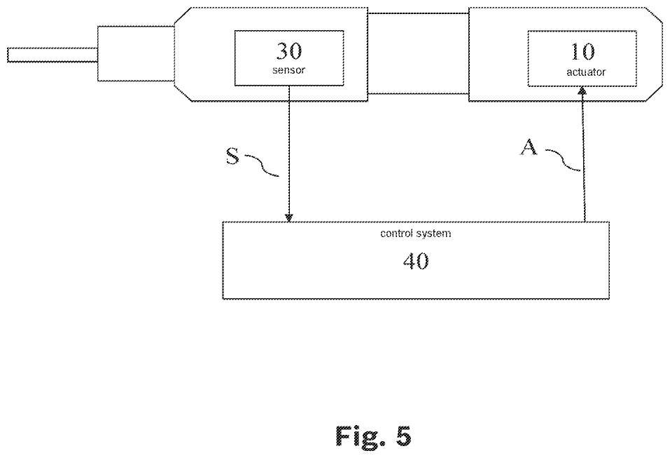

### DETAILED DESCRIPTION OF EXAMPLE EMBODIMENTS

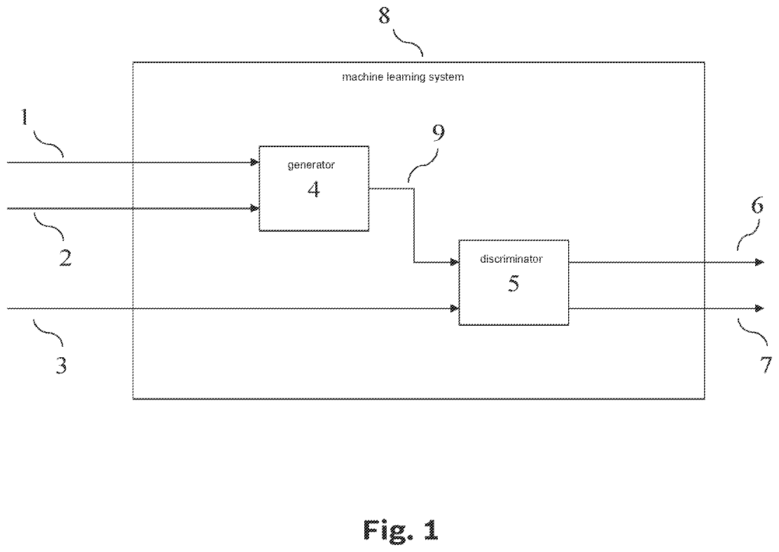

FIG. 1 shows an embodiment of a machine learning system (8). The machine learning system comprises a first part (4), which will be referred to as generator, and a second part (5), which will be referred to as discriminator. The machine learning system may be understood as a generative adversarial network. In the embodiment, the generator (4) and discriminator (5) may preferably be given by respective neural networks. The machine learning system (8) may hence also be understood as a larger neural network, wherein the generator (4) and discriminator (5) form sub-neural networks of the machine learning system (8). In further embodiments, the generator (4) and/or discriminator (5), may also be given by other machine learning models, e.g., support vector machines.

The figure shows how the machine learning system may be configured for training. The machine learning system is provided a first input signal (1), which is forwarded to the generator (4). The first input signal (1) characterizes a noisy signal, which the machine learning system (8) shall learn to denoise. The machine learning system (8) is also provided a randomly drawn first value (2), which is also forwarded to the generator (4). In the embodiment, the first value (2) is drawn from a standard normal distribution. In further embodiments, other probability distributions may be used as well for drawing a first value (2). In even further embodiments, the machine learning system may also be supplied with a vector (2) of first values, wherein the vector (2) is drawn from a multivariate probability distribution, preferably a standard multivariate normal distribution. The machine learning system (8) is also provided a second input signal (3), which characterizes a non-noisy signal, i.e., a clean signal. The second input signal (3) is forwarded to the discriminator (5).

The first input signal (1) and second input signal (3) may in particular be sensor signals received from a sensing device such as an optical device (e.g., a camera, a radar sensor, a LIDAR sensor, an ultrasonic sensor, a thermal sensor), a piezo sensor, a microphone or a sensor for measuring electrical current or voltage.

The generator (4) receives the first input signal (1) and the first value (2) and determines an output signal (9) based on the first input signal (1) and the first value (2). The output signal (9) may be understood as characterizing the same type of signal as the first signal (1). For example, if the first input signal (1) is an image, the output signal (9) can be understood as a denoised image obtained based on the first input signal (1).

The output signal (9), alongside the second input signal (2), is received by the discriminator (5). The discriminator (5) is configured to classify both the output signal (9) and the second input signal (3). For this, the discriminator (5) may assign a second value (6) to the output signal (9), wherein the second value (6) characterizes a probability of the output signal (9) to be a noisy signal. Also, the discriminator (5) may assign a third value (7) to the second input signal (3) characterizing a probability of the second input signal (3) to be a clean signal. For example, the second value (6) and the third value (7) may each characterize probabilities, log-likelihoods or preferably negative log-likelihoods.

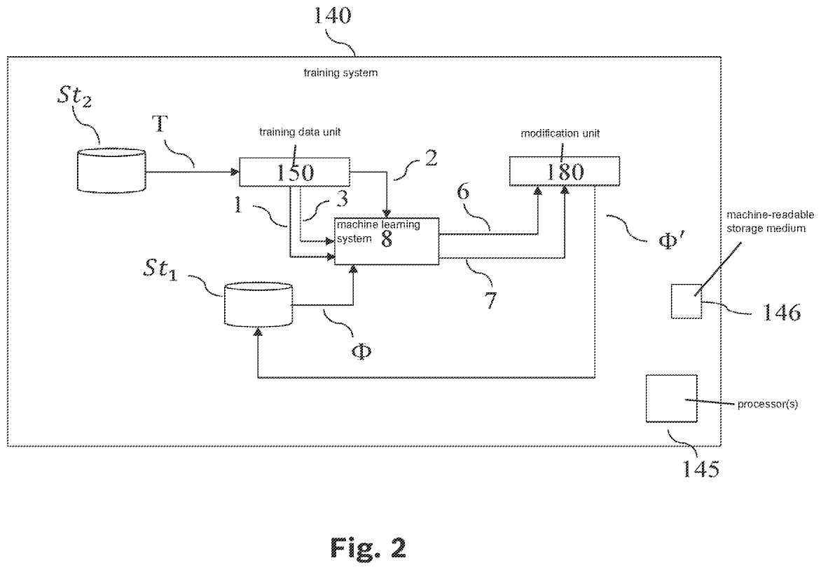

FIG. 2 shows an embodiment of a training system (140) for training the machine learning system (8). Training is conducted based on a training data set (T). The training data set (T) may comprises a plurality of first input signals (1), which characterize noisy signals, and a plurality of second input signal (3), which characterize clean signals. Alternatively, the training dataset (T) may also not comprise the plurality of first input signals (1). For training, the plurality of first input signals (1) may then be determined based on the plurality of second input signals (3), e.g., by selecting signals from the plurality of second input signals (3) and adding noise to the selected signals.

For training, a training data unit (150) accesses a computer-implemented database (St₂), wherein the database (St₂) provides the training data set (T). The training data unit (150) determines from the training data set (T) preferably randomly at least one first input signal (1) and at least one second output signal (2) supplies the at least one first input signal (1) and the at least one second output signal (2) to the machine learning system (8). Additionally, the training data unit (150) randomly determines a first value (2), preferably a vector of first values (2), and provides it to the machine learning system (8). If the training data set (T) does not comprise a first input signal (1), the training data unit (150) may also randomly selected a signal from the plurality of second input signals (3), add noise to it and provide the resulting noisy signal as first input signal (1) to the machine learning system (8). In other preferred embodiments, the training data unit (150) may also randomly select a batch of first input signals (1) and second input signals (3), wherein the batch size as well as ratio between first input signals (1) and second input signals (2) is a hyperparameter of the training procedure.

In any case, the at least one first input signal (1) and at least one second input signal (3) are forwarded to the machine learning system (8), which determines a second value (6) for each first input signal (1) and a third value (7) for each second input signal (3).

The second value (6) and third value (7) are then forwarded to a modification unit (180). Based on the second value (6) and the third value (7), the modification unit (180) then determines new parameters (Φ′) for the machine learning system (8). The new parameters (Φ′) comprise new parameters for the first part (4) and the second part (5) of the machine learning system (8). Preferably, determining the new parameters (Φ′) is achieved by means of a gradient descent method, wherein the gradient is determined based on a loss function. For determining the new parameters of the second part (5), the loss function is preferably characterized by a first formula

$${ℒ}_{D} = - \frac{1}{n} {\sum }_{i = 1}^{n} log D ( {x}_{i}^{( 2 )} ) - \frac{1}{m} {\sum }_{j = 1}^{m} log 1 - D ( G ( {x}_{j}^{( 1 )} , {z}_{j} ) ) ,$$

wherein D(⋅) characterizes the output of the second part (5) for a given input signal, xᵢ⁽²⁾ characterizes the i-th element of the plurality of second input signals (3), xⱼ⁽¹⁾ characterizes the j-th element of the plurality of first input signals (1), zⱼ the first value (2) corresponding to the j-th first input signal (1) and G(⋅,⋅) the output of the first part (4) for a given first input signal (1) and a corresponding first value (2). For determining new parameters of the first part (4), the loss function is preferably characterized by a second formula

$${ℒ}_{G} = - \frac{1}{m} {\sum }_{j = 1}^{m} log D ( G ( {x}_{j}^{( 1 )} , {z}_{j} ) ) .$$

Gradients are then preferably determined for the first part (4) according to the second formula and for the first part according to the first formula. As the machine learning system (8) may be understood as a special form of a GAN, known GAN training techniques may be used for training, e.g., training the first or second part for a predefined amount of iterations separately while fixing the parameters of the other part or spectral normalization. In the embodiment, m and n can be understood as hyperparameters of the training procedure.

Furthermore, the training system (140) may comprise at least one processor (145) and at least one machine-readable storage medium (146) containing instructions which, when executed by the processor (145), cause the training system (140) to execute a training method according to one of the aspects of the present invention.

In further embodiments, it is also possible that the machine learning system is trained to not denoise already non-noisy input signals. For this, the new parameters of the first part are additionally determined based on a loss function, which can be characterized by a third formula

$${ℒ}_{I} = \frac{1}{l} {\sum }_{k = 1}^{l} {‖ {x}_{k}^{( 3 )} - G ( {x}_{k}^{( 3 )} , 0 ) ‖}_{p} + {‖ G ( {x}_{k}^{( 3 )} , {z}_{1}^{( r )} ) - G ( {x}_{k}^{( 3 )} , {z}_{2}^{( r )} ) ‖}_{p} ,$$

wherein xₖ⁽³⁾ characterizes the k-th element of a plurality of k non-noisy input signals (referred to as third input signals), z₁^{(r)} and z₂^{(r)} are randomly drawn first values (2) and ∥⋅∥ₚ characterizes a p-norm, preferably the L₂-norm. Training the first part (4) may then be achieved based on determining a gradient with respect to a sum of the second formula and third formula, preferably by weighting the summands according to predefined factors.

In even further embodiments, the first part (4) may also be configured to determine a classification of the type of noise provided in the first input signal (1), e.g., additive noise, quantization error, multiplicative noise or shot noise. The machine learning system may especially be configured to determine a class characterizing the label “no noise” if an input signal is not noisy. The machine learning system may also be provided with a label of the first input signal (1), wherein the label characterizes a class of noise that the noise from the first input signal (1) belongs to. The new parameters for the first part (4) may then preferably be determined based on an additional loss function, which is characterized by a fourth formula

$${ℒ}_{cls} = - \frac{1}{n} {\sum }_{i = 1}^{n} log {sm}_{{c}_{i}} ( {G}_{c} ( {x}_{i}^{( 1 )} ) ) - \frac{1}{m} {\sum }_{j = 1}^{m} log {sm}_{C + 1} ( {G}_{c} ( {x}_{j}^{( 2 )} ) ) ,$$

wherein G_{c}(⋅) is the classification determined by the first part (4), sm_{c}_{ᵢ} is the softmax function evaluated at the class index cᵢ of the class of the first input signal xᵢ⁽¹⁾ and sm_{c+1} is the softmax function evaluated at the class index C+1, which characterizes the class “no noise”. The loss functions from the second, third and fourth formula may be added together in a weighted sum to form the total loss function which shall be optimized during training. In other words, the gradient used for training the first part (4) may especially be determined based on a loss function characterizing a weighted sum of the second, third and fourth formula.

The labels may also be obtained by clustering unlabeled first input signals (1) and assigning first input signals (1) in a cluster the same labels.

In even further embodiments, the third input signals may also be processed by the second summand of the fourth formula.

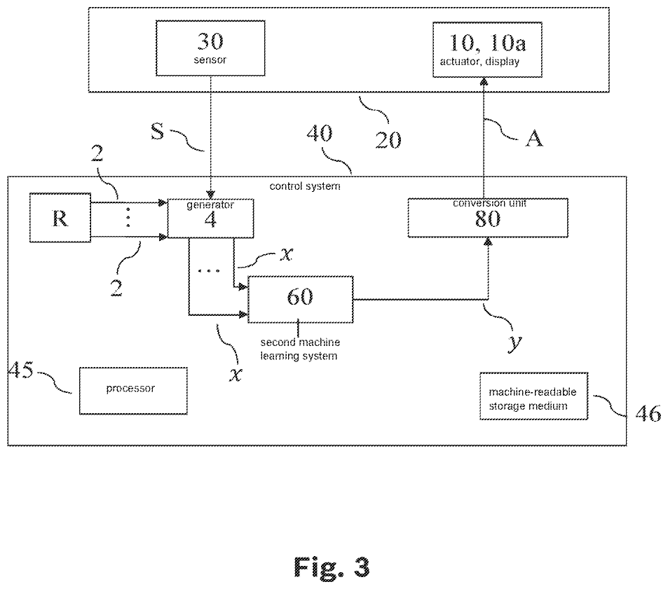

Shown in FIG. 3 is an embodiment of a control system (40) for controlling an actuator (10) in its environment. The actuator (10) and its environment (20) will be jointly called actuator system. At preferably evenly spaced points in time, a sensor (30) senses a condition of the actuator system. The sensor (30) may comprise several sensors. Preferably, the sensor (30) is an optical sensor that takes images of the environment (20). An output signal (S) of the sensor (30) (or, in case the sensor (30) comprises a plurality of sensors, an output signal (S) for each of the sensors) which encodes the sensed condition is transmitted to the control system (40).

Thereby, the control system (40) receives a stream of sensor signals (S). It then computes a series of control signals (A) depending on the stream of sensor signals (S), which are then transmitted to the actuator (10).

The control system (40) receives the stream of sensor signals (S) of the sensor (30) in the first part (4) of the machine learning system (8). Additionally, a random generator unit (R) determines randomly a plurality of first values (2) for each sensor signal (S). For each first value (2) and its sensor signal (S), the first part (4) determines an output signal (x). The output signal (x) may be understood as denoised signal (x). For each sensor signal (S) there hence exists a plurality of output signals (x). For an sensor signal (S), each output signal (x) is then processed by a second machine learning system (60), preferably a classifier or a machine learning model configured to perform a regression analysis. For each of the output signals (x) determined for a sensor signal (S), the second machine learning system determines an output, wherein the different outputs for the plurality of output signals (x) are then aggregated into an aggregated signal (y). For example, if the second machine learning system (60) is configured to perform a classification, the outputs determined from the second machine learning system (60) may be aggregated by means of majority voting to determine the aggregated signal (y). If the second machine learning system (60) is configured to perform a regression analysis, the different outputs for the plurality of output signals (x) may be summed or averaged in order to determine the aggregated signal (y).

In further embodiments, the aggregated signal (y) may further comprise a value characterizing a variance of the different outputs determined from the machine learning system (60), e.g., a standard deviation of the different outputs.

The aggregated signal (y) is transmitted to an optional conversion unit (80), which converts the aggregated signal (y) into the control signals (A). The control signals (A) are then transmitted to the actuator (10) for controlling the actuator (10) accordingly. Alternatively, the aggregated signal (y) may directly be taken as control signal (A).

The actuator (10) receives control signals (A), is controlled accordingly and carries out an action corresponding to the control signal (A). The actuator (10) may comprise a control logic which transforms the control signal (A) into a further control signal, which is then used to control actuator (10).

In further embodiments, the control system (40) may comprise the sensor (30). In even further embodiments, the control system (40) alternatively or additionally may comprise an actuator (10).

In still further embodiments, it can be envisioned that the control system (40) controls a display (10a) instead of or in addition to the actuator (10).

Furthermore, the control system (40) may comprise at least one processor (45) and at least one machine-readable storage medium (46) on which instructions are stored which, if carried out, cause the control system (40) to carry out a method according to an aspect of the present invention.

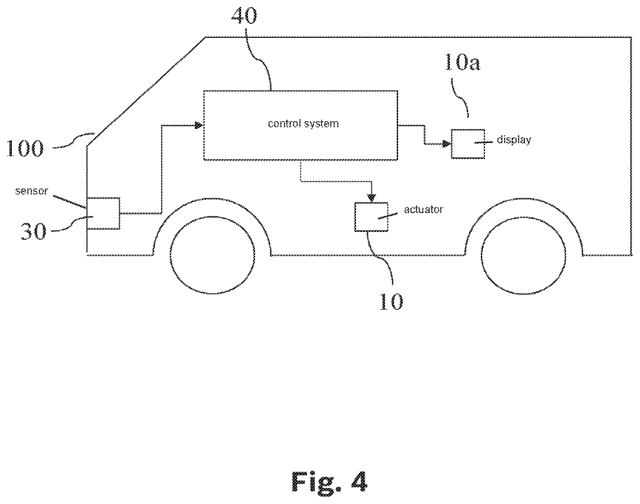

FIG. 4 shows an embodiment in which the control system (40) is used to control an at least partially autonomous robot, e.g., an at least partially autonomous vehicle (100).

The sensor (30) may comprise one or more video sensors and/or one or more radar sensors and/or one or more ultrasonic sensors and/or one or more LiDAR sensors. Some or all of these sensors are preferably but not necessarily integrated in the vehicle (100). The denoised signal (x) may hence be understood as an image and the second machine learning system (60) as an image classifier or image regressor (i.e., a model configured for image regression).

The second machine learning system (60) may be configured to detect objects in the vicinity of the at least partially autonomous robot based on a supplied output signal (x). The aggregated signal (y) may comprise an information, which characterizes where objects are located in the vicinity of the at least partially autonomous robot. Additionally, the aggregated signal (y) may comprise information regarding the variance of the position and/or extension of objects, e.g., in the form of an uncertainty value. The control signal (A) may then be determined in accordance with any one or all of these information, for example to avoid collisions with the detected objects.

The variance information comprised by the aggregated signal (y) may, e.g., be used in a Kalman filter for tracking the objects detected in the denoised signals (x), wherein the variance information may be used to as variance of the observation noise.

The actuator (10), which is preferably integrated in the vehicle (100), may be given by a brake, a propulsion system, an engine, a drivetrain, or a steering of the vehicle (100). The control signal (A) may be determined such that the actuator (10) is controlled such that vehicle (100) avoids collisions with the detected objects. The detected objects may also be classified according to what the image classifier (60) deems them most likely to be, e.g., pedestrians or trees, and the control signal (A) may be determined depending on the classification.

Alternatively or additionally, the control signal (A) may also be used to control the display (10a), e.g., for displaying the objects detected by the second machine learning system (60). It is also possible that the control signal (A) may control the display (10a) such that it produces a warning signal, if the vehicle (100) is close to colliding with at least one of the detected objects. The warning signal may be a warning sound and/or a haptic signal, e.g., a vibration of a steering wheel of the vehicle.

In further embodiments, the at least partially autonomous robot may be given by another mobile robot (not shown), which may, for example, move by flying, swimming, diving or stepping. The mobile robot may, inter alia, be an at least partially autonomous lawn mower, or an at least partially autonomous cleaning robot. In all of the above embodiments, the control signal (A) may be determined such that propulsion unit and/or steering and/or brake of the mobile robot are controlled such that the mobile robot may avoid collisions with said identified objects.

FIG. 4 shows an embodiment for controlling a valve (10). In the embodiment, the sensor (30) is a pressure sensor that senses a pressure of a fluid that can be output by the valve (10). In particular, the second machine learning system (60) may be configured to accurately determine an injection amount of fluid dispensed by the valve (10) based on the time series (x) of pressure values.

In particular, the valve (10) may be part of a fuel injector of an internal combustion engine, wherein the valve (10) is configured to inject the fuel into the internal combustion engine. Based on the determined injection quantity, the valve (10) can then be controlled in future injection processes in such a way that an excessively large quantity of injected fuel or an excessively small quantity of injected fuel is compensated for accordingly.

Alternatively, it is also possible that the valve (10) is part of an agricultural fertilizer system, wherein the valve (10) is configured to spray a fertilizer. Based on the determined amount of fertilizer sprayed, the valve (10) can then be controlled in future spraying operations in such a way that an excessive amount of fertilizer sprayed or an insufficient amount of fertilizer sprayed is compensated for accordingly.

The term “computer” may be understood as covering any devices for the processing of pre-defined calculation rules. These calculation rules can be in the form of software, hardware or a mixture of software and hardware.

In general, a plurality can be understood to be indexed, that is, each element of the plurality is assigned a unique index, preferably by assigning consecutive integers to the elements contained in the plurality. Preferably, if a plurality comprises N elements, wherein N is the number of elements in the plurality, the elements are assigned the integers from 1 to N. It may also be understood that elements of the plurality can be accessed by their index.

1-15. (canceled)

16. A computer-implemented method for determining a classification and/or regression result based on a provided input signal, the method comprising the following steps:
providing a first part, wherein the first part is configured to denoise the provided input signal based on the input signal and a randomly drawn first value;
randomly drawing a plurality of first values;
determining, by the first part, a plurality of denoised signals, wherein each denoised signal from the plurality of denoised signals is determined based on the input signal and a first value from the plurality of first values;
determining, by a model, a plurality of predicted values based on the denoised signals, wherein each predicted value characterizes a classification of a denoised signal or a regression result based on a denoised signal; and
providing an aggregated signal characterizing an aggregation of the predicted values, wherein the aggregated signal characterizes the classification and/or regression result determined by the method.

17. The method according to claim 16, wherein a third value is provided by the method, wherein the third value characterizes a variance of the predicted values.

18. The method according to claim 16, wherein the first part is provided based on training the first part to denoise a provided input signal, wherein the training of the first part includes the following steps:
providing a first input signal and a first value to the first part, wherein the first input signal characterizes a noisy signal and the first value characterizes a randomly drawn value;
determining, by the first part, a first output signal for the first input signal and the first value;
determining, by a second part, a second value based on the first output signal, wherein the second value characterizes a probability of the first output signal to characterize a noisy signal;
determining, by the second part, a third value based on a supplied second input signal, wherein the second input signal characterizes a non-noisy signal and wherein the third value characterizes a probability of the second input signal to characterize a non-noisy signal;
training the first part and the second part, wherein the training includes:
adapting a plurality of parameters of the first part according to a gradient of the second value with respect to the plurality of parameters of the first part, and
adapting a plurality of parameters of the second part according to a gradient of a sum of the second value and the third value with respect to the plurality of parameters of the second part.

19. The method according to claim 18, wherein the method further comprises the following steps:
providing a third input signal and a fourth value to the first part, wherein the third input signal characterizes a non-noisy signal;
determining, by the first part, a second output signal for the third input signal and the fourth value; and
adapting a plurality of parameters of the first part according to a deviation of the second output signal from the third input signal.

20. The method according to claim 18, wherein the method further comprises the following steps:
determining, by the first part and based on the first input signal and the first value, a fifth value characterizing a classification of the type of noise characterized by the first input signal;
adapting a plurality of parameters of the first part according to a deviation of a class characterized by the fifth value and a class of noise type corresponding to the first input signal.

21. The method according to claim 20, wherein the method further comprises the following steps:
determining, by the first part and based on the third input signal and the fourth value, a fifth value characterizing a classification of the type of noise characterized by the third input signal;
adapting a plurality of parameters of the first part according to a deviation of a class characterized by the fifth value and a class characterizing an absence of noise.

22. The method according to claim 19, wherein the deviation of the second output signal to the third input signal is characterized by the formula [symbol]
_{G,id}= [symbol] ₓ_{⁽³⁾}{∥x⁽³⁾−G(x⁽³⁾, z=0)∥ₚ}+ [symbol] ₓ_{⁽³⁾}_{,z}_{₁}_{,z}_{₂}{∥G(x⁽³⁾, z=z₁)−G(x⁽³⁾, z=z₂)μₚ},
wherein x⁽³⁾ is the third input signal and G is the first part.

23. A computer-implemented method for determining a denoised signal from an input signal, comprising the following steps:
providing a first part, wherein the first part is configured to denoise an input signal based on the input signal and a randomly drawn first value;
determining a denoised signal by the first part based on the input signal and a randomly drawn first value; and
providing an output signal as the denoised

24. The method according to claim 23, wherein the provided first part has been trained to denoise a provided input signal, wherein the training of the first part includes the following steps:
providing a first input signal and a first value to the first part, wherein the first input signal characterizes a noisy signal and the first value characterizes a randomly drawn value;
determining, by the first part, a first output signal for the first input signal and the first value;
determining, by a second part, a second value based on the first output signal; wherein the second value characterizes a probability of the first output signal to characterize a noisy signal;
determining, by the second part, a third value based on a supplied second input signal, wherein the second input signal characterizes a non-noisy signal and wherein the third value characterizes a probability of the second input signal to characterize a non-noisy signal;
training the first part and the second part, wherein the training includes:
adapting a plurality of parameters of the first part according to a gradient of the second value with respect to the plurality of parameters of the first part, and
adapting a plurality of parameters of the second part according to a gradient of a sum of the second value and the third value with respect to the plurality of parameters of the second part.

25. The method according to claim 23, wherein the denoised signal is used as input of a control system, wherein the control system is configured to determine a control signal of an actuator based on the denoised signal.

26. The method according to claim 23, wherein the denoised signal is used as input to a virtual sensor for determining a property of the input signal that is not measured by the input signal itself.

27. The method according to claim 16, wherein the input signal is a sensor signal.

28. A training system, configured to train a first part to denoise a provided input signal, wherein the training system is configured to:
provide a first input signal and a first value to the first part, wherein the first input signal characterizes a noisy signal and the first value characterizes a randomly drawn value;
determine, by the first part, a first output signal for the first input signal and the first value;
determine, by a second part, a second value based on the first output signal, wherein the second value characterizes a probability of the first output signal to characterize a noisy signal;
determine, by the second part, a third value based on a supplied second input signal, wherein the second input signal characterizes a non-noisy signal and wherein the third value characterizes a probability of the second input signal to characterize a non-noisy signal;
train the first part and the second part, wherein the training includes:
adapting a plurality of parameters of the first part according to a gradient of the second value with respect to the plurality of parameters of the first part, and
adapting a plurality of parameters of the second part according to a gradient of a sum of the second value and the third value with respect to the plurality of parameters of the second part.

29. A non-transitory machine-readable storage medium on which is stored a computer program for determining a classification and/or regression result based on a provided input signal, the computer program, when executed by a computer, causing the computer to perform the following steps:
providing a first part, wherein the first part is configured to denoise the provided input signal based on the input signal and a randomly drawn first value;
randomly drawing a plurality of first values;
determining, by the first part, a plurality of denoised signals, wherein each denoised signal from the plurality of denoised signals is determined based on the input signal and a first value from the plurality of first values;
determining, by a model, a plurality of predicted values based on the denoised signals, wherein each predicted value characterizes a classification of a denoised signal or a regression result based on a denoised signal; and
providing an aggregated signal characterizing an aggregation of the predicted values, wherein the aggregated signal characterizes the classification and/or regression result
